(19) United States
(12) Patent Application Publication
(10) Pub. No.: US 2002/0030795 A1
(43) Pub. Date: Mar. 14, 2002

(54) Illumination apparatus and projection type display apparatus using the same

(75) Inventor: Chikara Yamamoto, Saitama-shi (JP)

Correspondence Address: Ronald R. Snider, Snider & Associates, P.O. Box 27613, Washington, DC, 20038-7613, US

(73) Assignee: Fuji Photo Optical Co., Ltd., Saitama-shi (JP)

(21) Appl. No.: 09/893,011

(22) Filed: Jun. 28, 2001

(30) Foreign Application Priority Data
Jul. 19, 2000 (JP) 2000-218924

(51) Int. Cl. G03B 21/28

(52) U.S. Cl. 353/94; 353/99

(57) ABSTRACT

An illumination apparatus comprises a plurality of light source sections, an integrator section, and a mirror element. Each light source section is constituted by a luminous body and a reflector comprising an ellipsoidal surface having one focal point located near the center of gravity of the luminous body. The integrator section is constituted by at least two integrator plates, arranged in the optical axis direction of light, for homogenizing the quantity of light emitted from the light source sections. The mirror element has a reflecting surface near the other focal point of the ellipsoidal surface of at least one reflector, and reflects the luminous flux from the light source group toward the integrator section. The optical axis of the illumination apparatus as a whole and the optical axis of at least one reflector form a predetermined angle therebetween.

### RELATED APPLICATIONS

This application claims the priority of Japanese Patent Application No. 2000-218924 filed on Jul. 19, 2000, which is incorporated herein by reference.

### BACKGROUND OF THE INVENTION

1. Field of the Invention

The present invention relates to an illumination apparatus, and a projection type display apparatus which modulates the output light from the illumination apparatus according to predetermined image information by using a light valve and projects thus modulated light onto a screen; and, in particular, to a configuration of an illumination apparatus comprising a plurality of light source sections.

2. Description of the Prior Art

Methods using a lens array or a lenticular plate have conventionally been known as an integrator type in illumination apparatus employed in projection type display apparatus. Even when a light source having uneven light-distributing characteristics, such as a metal halide lamp, xenon lamp, or halogen lamp is used, this type of methods can yield an illumination apparatus which can eliminate the unevenness in illumination on the light valve caused by light-distributing characteristics of the light source.

Such an illumination apparatus comprises a first integrator plate (known as a second flyeye or the like in general) and a second integrator plate (known as a first flyeye or the like in general) are successively disposed in this order downstream a light source section using a reflector. The first integrator plate is constituted by a plurality of two-dimensionally arranged lens elements, each having a form substantially similar to that of the liquid crystal display panel. A luminous flux with a large unevenness in brightness emitted from the light source section is divided by the first integrator plate into partial luminous fluxes whose number is identical to the number of lens elements in the first integrator plate. The unevenness in brightness of partial luminous fluxes is smaller than that of the undivided luminous flux. The partial luminous fluxes form respective secondary light sources on the surface of the second integrator plate (which becomes conjugate with the pupil surface of a projection lens), which are emitted toward the illuminating region by way of the second integrator plate and a field lens, so as to be superposed on each other, whereby illumination with a smaller unevenness in brightness can be realized.

Known as the projection type display apparatus using two integrator plates as mentioned above is one having a plurality of light sources arranged symmetrical about the optical axis in order to secure the quantity of illumination light, and so forth (Japanese Unexamined Patent Publication No. 6-265887).

In the case of an illumination apparatus comprising a single light source, the unevenness in illumination caused by light-distributing characteristics of the light source can effectively be eliminated by the above-mentioned integrator type. In an illumination apparatus in which a plurality of light sources are arranged symmetrical about the optical axis, however, a new intensity distribution occurs due to light-distributing characteristics of the light sources. Namely, since individual light sources having respective intensity distributions different from each other are arranged symmetrical about the optical axis, a part having a high intensity occurs at a position not near the optical axis but separated from the optical axis by a predetermined distance on the pupil surface of the projection lens, which becomes conjugate with the surface of the second integrator plate. However, the imaging performance of the projection lens is higher in the vicinity of the optical axis and becomes lower as being distanced further therefrom. If a part having a higher intensity, i.e., a part governing the imaging performance, exists at a position separated from the optical axis on the pupil surface by a predetermined distance as mentioned above, it becomes harder to fully exhibit the imaging performance inherent in the projection lens.

A conventional example which can deal with such a problem caused by a plurality of light sources is the illumination apparatus and the projection type display apparatus using the same disclosed in Japanese Unexamined Patent Publication No. 2000-3612. This illumination apparatus comprises a plurality of light source sections each comprising an ellipsoidal mirror having a first focal point near the center of gravity of a luminous body, whereas the luminous flux from each light source section is reflected toward the integrator by a reflecting prism having a reflecting surface near a second focal point of each ellipsoidal mirror. Therefore, the secondary light source of luminous body formed on the reflecting surface of the reflecting prism is located nearer to the optical axis of the illumination apparatus than is the luminous body itself, whereby the position of the secondary light source can be taken as the light source position in its downstream optical systems. Thus, while this apparatus is a bright illumination apparatus comprising a plurality of light sources, a light spot is formed by the luminous flux from each light source section at a position near the optical axis on the pupil surface of the projection lens, whereby the imaging performance of the projection lens can be made favorable.

However, the apparatus mentioned above aims at improving the uniformity in illuminance and color of the illumination light. Therefore, it is considered important for luminous body images formed on the projection lens pupil surface to be arranged substantially symmetrical about the optical axis even when a plurality of lamps are used. Namely, the luminous body images are arranged substantially symmetrical about the optical axis, whereby the light spot formed by the luminous flux from each light source section is resultantly positioned near the optical axis. Hence, this apparatus is not necessarily conceived to cause the above-mentioned projection lens to fully exhibit its imaging performance.

As mentioned above, the imaging performance of projection lens is higher in the vicinity of the optical axis and becomes lower as being separated farther therefrom. Therefore, in order to utilize the imaging performance of the projection lens most effectively, it is desirable that the part having a higher luminous flux intensity be transmitted through the pupil surface of the projection lens at a position as close to the optical axis as possible. Though the light spot formed by the luminous flux from each light source section can be formed at a position close to the optical axis to a certain extent in this conventional example, there is a limit. Namely, as the light spot approaches the optical axis, the position at which the luminous flux from the light source section is reflected on each reflecting surface of the reflecting prism inevitably approaches a vertex of the reflecting prism formed by reflecting surfaces of the reflecting prism. However, a certain area is necessary for reflecting a luminous flux even in the vicinity of the focal position of the luminous flux, whereby no luminous flux can be reflected by a vertex of the reflection prism.

Therefore, a paradigm shift is necessary for causing the part with a higher intensity of the luminous flux from a light source section to pass through the pupil surface of the projection lens at a position nearer to the optical axis, and further effectively utilizing the imaging performance of the projection lens.

### SUMMARY OF THE INVENTION

In view of such circumstances, it is an object of the present invention to provide an illumination apparatus which can easily be made smaller and can cause the projection lens to fully exhibit the imaging performance inherent therein by placing the part with a higher light intensity corresponding to each light source as nearer to the optical axis of the illumination apparatus as possible when a plurality of light sources are arranged symmetrical about the optical axis while the illumination light is homogenized by the integrator type.

It is another object of the present invention to provide a projection type display apparatus comprising the above-mentioned illumination apparatus.

The present invention provides an illumination apparatus comprising:

a light source group in which a plurality of light source sections, each constituted by a luminous body and a reflector comprising an ellipsoidal surface having one focal point located near a center of gravity of the luminous body, are arranged;

an integrator section, constituted by at least two integrator plates, for homogenizing a quantity of light emitted from the light source group, the integrator section being arranged in an optical axis direction of the light; and

at least one mirror element, having a reflecting surface near the other focal point of the ellipsoidal surface of at least one reflector, for reflecting a luminous flux from the light source group toward the integrator section;

wherein the illumination apparatus as a whole has an optical axis forming a predetermined angle with an optical axis of the at least one reflector.

Preferably, at least one lens for emitting the luminous flux from the mirror element toward the integrator section as a substantially parallel luminous flux is disposed on the mirror element side of the integrator section.

Preferably, the lens is formed integrally with the integrator plate on the mirror element side in the integrator section on the surface of the integrator plate facing the mirror element.

The lens may be formed integrally with the integrator plate from a plastic material.

The light source group may comprise at least two light source sections arranged such that respective luminous fluxes therefrom are incident on the lens at an angle by which a center axis of each of the luminous fluxes substantially intersects the optical axis of the lens.

The light source group may comprise at least two light source sections, whereas the mirror element has a reflecting surface near the other focal point of the ellipsoidal surface of each of the reflectors of the two light source sections so as to reflect the luminous flux from the light source group toward the integrator section.

The present invention provides a projection type display apparatus comprising the above-mentioned illumination apparatus, a light valve for modulating output light from the integrator section according to predetermined image information, and a projection lens for projecting onto a screen an optical image formed by the light modulated by the light valve.

Here, “the illumination apparatus as a whole has an optical axis forming a predetermined angle with the optical axis of the at least one reflector” indicates that, in a state where the luminous flux from the reflector is assumed to be focused once and then become incident on the integrator section while being kept on linearly advancing without the mirror element, the optical axis of the illumination apparatus as a whole and the optical axis of the reflector have such an angle therebetween that the distance from the optical axis of the whole illumination apparatus to the center of gravity of the luminous body is greater than the distance from the optical axis of the whole illumination apparatus to the focal point. Namely, in thus assumed state, the optical axis of the reflector intersects the optical axis of the whole illumination apparatus on its extension directed to the focal point.

### BRIEF DESCRIPTION OF THE DRAWINGS

FIG. 1 is a schematic view showing the main part of the illumination apparatus in accordance with an embodiment of the present invention;

FIG. 2 is a schematic view showing the projection type display apparatus in accordance with an embodiment of the present invention;

FIG. 3 is a schematic view showing an integrated lens employable in the illumination apparatus of FIG. 1; and

FIG. 4 is a schematic view showing the main part of a conventional illumination apparatus.

### DESCRIPTION OF THE PREFERRED EMBODIMENTS

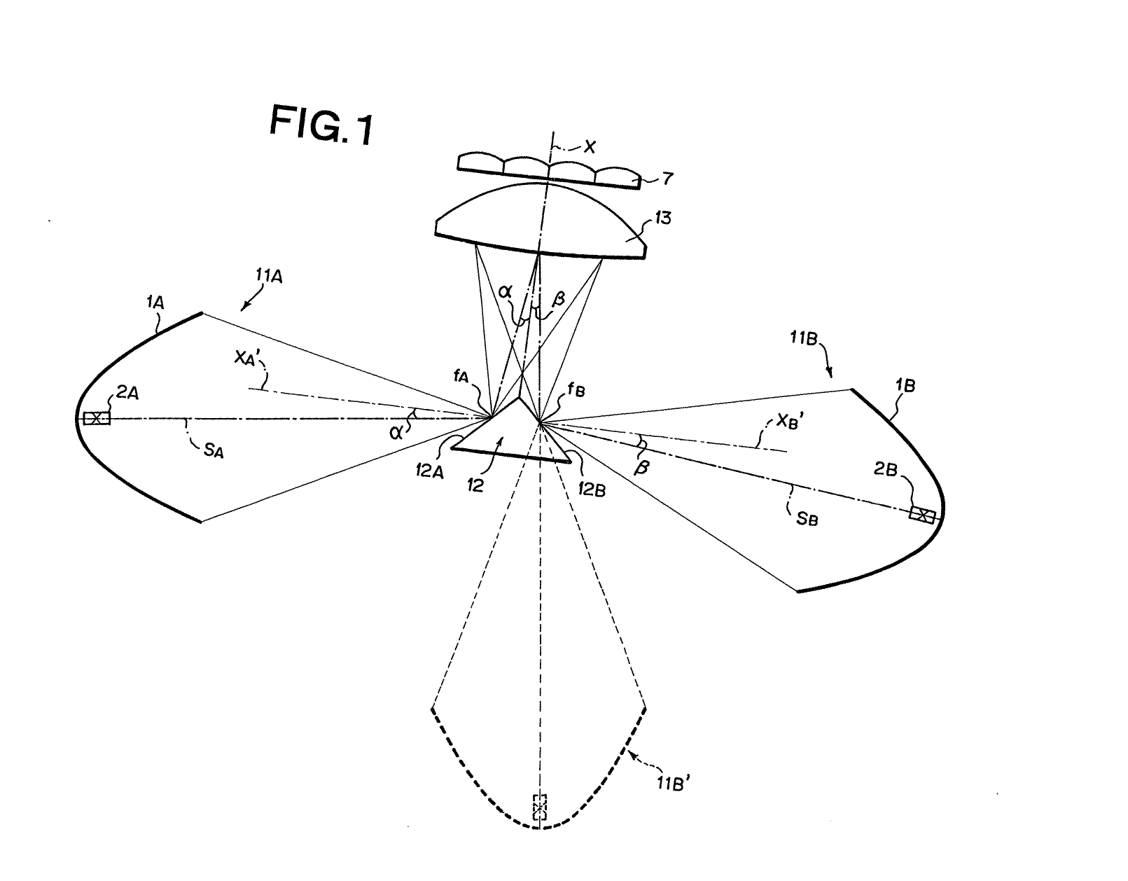

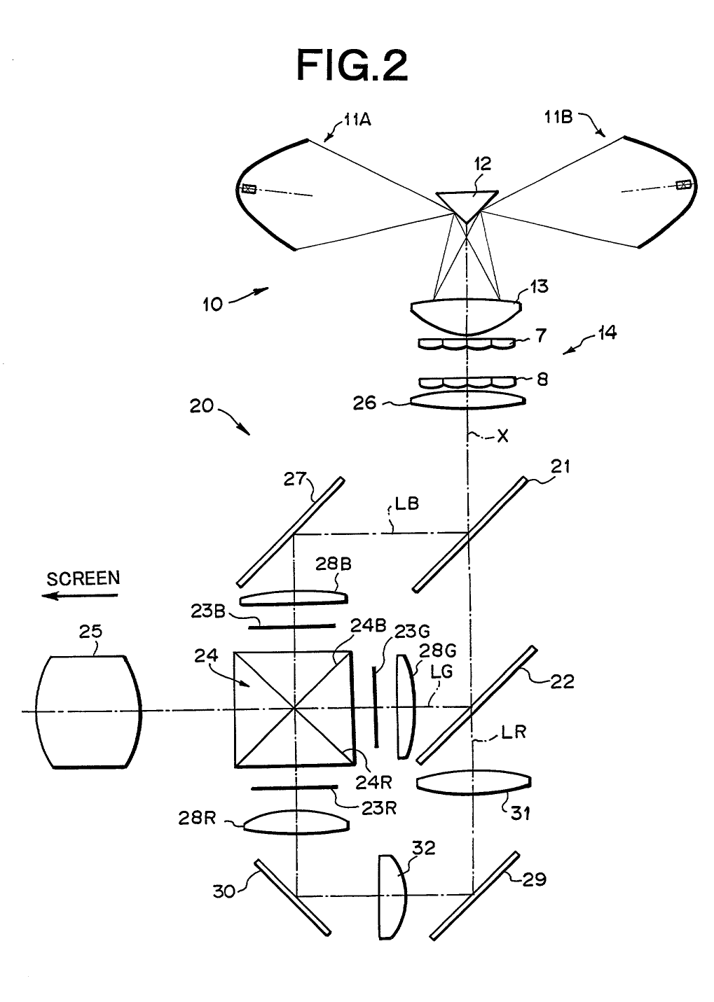

In the following, embodiments of the present invention will be explained with reference to the drawings. FIG. 2 is a view showing the configuration of the projection type display apparatus comprising the illumination apparatus in accordance with the present invention. This projection type display apparatus comprises an illumination apparatus 10 in accordance with the present invention, and a projector section 20 for causing a luminous flux emitted from the illumination apparatus 10 and turned into uniform light to carry image information and projecting it onto a screen. FIG. 1 is an enlarged view of a part of the illumination apparatus 10 shown in FIG. 2. With reference to FIGS. 1 and 2, the illumination apparatus 10 will now be explained. In the illumination apparatus 10, a luminous flux emitted from its light source group is turned into a substantially parallel luminous flux whose part with a higher light intensity is placed nearer to the optical axis of an integrator section 14, i.e., the optical axis X of the whole illumination apparatus, before being made incident on the integrator section 14, and then is mixed at the integrator section 14 so as to homogenize the light quantity distribution.

Here, the light source group comprises a plurality of (two in this embodiment) light source sections 11A, 11B comprising luminous bodies 2A, 2B, each made of a discharge tube such as a xenon lamp or metal halide lamp, and reflectors 1A, 1B, each made of an ellipsoidal mirrors, arranged symmetrical about the optical axis X of the illumination apparatus 10. The light-emitting source of the luminous body 2A, 2B is disposed on one focal point of the reflector 1A, 1B made of an ellipsoidal mirror. As a consequence, the luminous flux emitted from the luminous body 2A, 2B toward the rear side and outside of the optical axis of the reflector 1A, 1B, i.e., the optical axis S_{A}, S_{B} of the light source section 11A, 11B is reflected so as to be converged at the other focal point f_{A}, f_{B} of the reflector 1A, 1B to form a secondary light source image.

A mirror element 12 has reflecting surfaces 12A, 12B located near the other focal points f_{A}, f_{B} of the reflectors 1A, 1B, and reflects the luminous flux from each light source section 11A, 11B toward the integrator section 14. The respective divergent luminous fluxes from the focal points f_{A}, f_{B} on the reflecting surfaces 12A, 12B are transmitted through a lens 13, so as to be made incident on the integrator section 14 as substantially parallel luminous fluxes. In this embodiment, the lens 13 is constituted by a single aspherical lens having a positive refracting power. The form of the aspheric surface is defined by the following aspheric surface form expression:

$$Z = \frac{\frac{{Y}^{2}}{R}}{1 + \sqrt{1 - K \frac{{Y}^{2}}{{R}^{2}}}} + {AY}^{4} + {BY}^{6} + {CY}^{8} + {DY}^{10}$$

where

Z is the length of the perpendicular to a tangential plane (plane perpendicular to the optical axis) of an apex of the aspheric surface from a point on the aspheric surface having a height Y from the optical axis;

R is the paraxial radius of curvature of the aspheric surface;

Y is the height from the optical axis;

K is the eccentricity; and

A, B, C, and D are the fourth-, sixth-, eighth-, and tenth-order aspheric surface coefficients.

In FIG. 1, the lens 13 has the aspheric surface directed toward the integrator section 14. When the lens 13 has an aspheric surface, the aberration can be corrected favorably, and the illumination efficiency can be improved.

The upper part of Table 1 shows the radius of curvature R (mm) of each lens surface, center thickness D (mm) of the lens, and the refractive index Nₑ of the lens at e-line concerning the lens usable as an example of the aspherical lens. In this table, the numbers referring to the symbols successively increase from the light source section side. The lower part of Table 1 shows the respective values of constants K, A, B, C, and D of the aspheric surface indicated by the aspheric surface form expression.

The integrator section 14 comprises two integrator plates (first and second flyeyes 8, 7) and a field lens 26 arranged in the optical axis X direction. The substantially parallel luminous flux from the lens 13 is divided by the second flyeye 7 into partial luminous fluxes whose number is identical to the number of lens elements in the second flyeye 7, whereby tertiary light source images of the luminous bodies 2A, 2B are formed on individual lens elements constituting the first flyeye 8. These partial luminous fluxes are superposed onto a liquid crystal panel 23, which will be explained later, by the first flyeye 8 and the field lens 26, whereby the light quantity is homogenized within a cross section of the illumination apparatus perpendicular to the optical axis X.

As depicted, this embodiment is configured such that the optical axis X of the whole illumination apparatus forms predetermined angles with the optical axes S_{A}, S_{B} of the reflectors 1A, 1B, respectively. In the case of the light source section 11B, for example, the predetermined angle is expressed by the angle (β) formed between the optical axis X of the whole illumination apparatus and the optical axis S_{B} of the reflector 1B in the state where, without the mirror element 12, the luminous flux from the reflector 1B is assumed to form the focal point f_{B} and then become incident on the integrator section 14 by way of the lens 13 while being kept on linearly advancing. FIG. 1 shows the position of the light source section 11B and luminous flux lines therefrom as a light source section 11B′ by broken lines. In thus assumed state, as shown in FIG. 1, the angle β is set to such an angle that the distance from the optical axis X of the whole illumination apparatus to the center of gravity of the luminous body 2B is longer than the distance from the optical axis X of the whole illumination apparatus to the focal point f_{B}. Also, as depicted, the optical axis S_{B} of the reflector 1B intersects the optical axis X of the whole illumination apparatus on its extension directed to the focal point f_{B}.

In the state where the optical axis X is assumed to be bent by the mirror element 12, as depicted, the angle β can also be expressed as the angle formed between a dash-single-dot line X_{B}′ to which thus bent optical axis X is translated and the optical axis S_{B} of the reflector 1B.

As mentioned above, the angle β is such an angle that the distance from the optical axis X of the whole illumination apparatus to the center of gravity of the luminous body 2B is longer than the distance from the optical axis X of the whole illumination apparatus to the focal point f_{B}. Consequently, the position of the secondary light sources of luminous body 2B formed on the reflecting surface 12B of the mirror element 12 is nearer to the optical axis X of the illumination apparatus than is the position of the luminous body 2B itself. Therefore, the position of secondary light sources can be taken as the light source position in the optical systems downstream thereof. Since the optical axis X of the whole illumination apparatus and the optical axis S_{A} of the reflector 1A form an angle a therebetween, the luminous flux from the light source section 11A can also approach the optical axis X as shown in FIG. 1. Since the mirror element 12 is disposed, secondary light sources located nearer to the optical axis X as such can be obtained easily. As can be seen from FIG. 1, it is physically difficult to place the light source section 11A at a position symmetrical to the light source section 11B′ about the optical axis X.

In this embodiment, secondary light sources can be disposed at positions nearer to the optical axis X than are the luminous bodies 2A, 2B as in the above-mentioned conventional example. Also, since the optical axis X of the whole illumination apparatus forms predetermined angles α, β with the optical axes S_{A}, S_{B} of the reflectors 1A, 1B, respectively, the luminous fluxes from the reflectors 1A, 1B can approach the optical axis X to such an extent that the optical axes S_{A}, S_{B} thereof substantially intersect the optical axis X at the time when they enter the lens 13 as shown in FIG. 1. This also means that the light spots of luminous fluxes from the reflectors 1A, 1B incident on the lens 13 are substantially superposed on each other at the entrance surface of the lens 13 as depicted.

The luminous fluxes entering the lens 13 in such a state and then emitted as substantially parallel luminous fluxes toward the second flyeye 7 are those in which a part having a higher intensity is collected near the optical axis X of the illumination apparatus. In the illumination apparatus of this embodiment, the part of luminous flux having a higher intensity can also pass through the surface of the first flyeye 8, which becomes conjugate with the pupil surface of a projection lens 25, at a position near the optical axis. When the part having a higher intensity is collected in the vicinity of the optical axis on the pupil surface of the projection lens 25 as such, the imaging performance of the projection lens 25, which is higher in the vicinity of the optical axis and becomes lower as being separated farther therefrom, can fully be exhibited.

In terms of the configuration downstream the integrator section 14, it is desirable that the luminous fluxes from the light source sections 11A, 11B be substantially parallel luminous fluxes at the time when entering the second flyeye 7. Therefore, these luminous fluxes are required to have angles α, β which do not become too large at the time when entering the lens 13. When the reflectors 1A, 1B are to be disposed such that the optical axes S_{A}, S_{B} simply incline with respect to the optical axis X and superpose light spots onto the entrance surface of the lens 13, it will be sufficient if the angles α, β are made greater, without requiring the mirror element 12 to be disposed. In order for the angles α, β to be made as small as possible while the light spots are superposed as being centered at the optical axis X, the configuration comprising the light source sections 11A, 11B inclined with respect to the optical axis X, and the mirror as in this embodiment is effective.

A projection type display apparatus comprising such an illumination apparatus 10 will now be explained with reference to FIG. 2. As mentioned above, luminous fluxes in which the light quantity is homogenized and the part having a higher intensity is collected in the vicinity of the optical axis of the illumination apparatus 10 are made incident on the projector section 20. The projector section 20 comprises a B/GR separating dichroic mirror 21 for separating the luminous flux homogenized by the integrator section 14 into a B component LB and GR components LG, LR; a G/R separating dichroic mirror 22 for separating the GR components LG, LR emitted from the B/GR separating dichroic mirror 21 into a G component LG and an R component LR; a liquid crystal panel 23B for displaying an image for the B component; a liquid crystal panel 23G for displaying an image for the G component; a liquid crystal panel 23R for displaying an image for the R component; a tricolor-combining prism 24 for combining the luminous flux components LB, LG, LR carrying image information after being transmitted through the respective liquid crystal panels 23B, 23G, 23R; and a projection lens 25 for forming an image of the luminous flux composed by the tricolor-combining prism 24 onto a screen.

The projector section 20 further comprises a total reflection mirror 27 by which the B component LB emitted from the B/GR separating dichroic mirror 21 is reflected toward the liquid crystal panel 23B; a field lens 28B by which the B component LB reflected by the total reflection mirror 27 is turned into parallel light; a field lens 28G by which the G component LG emitted from the G/R separating dichroic mirror 22 is turned into parallel light; total reflection mirrors 29, 30 by which the R component LR emitted from the G/R separating dichroic mirror 22 is reflected toward the liquid crystal panel 23R; and a field lens 28R by which the R component LR emitted from the G/R separating dichroic mirror 22 is turned into parallel light.

Though only the R component LR has a different optical path length to the tricolor-combining prism 24 in the projector section 20, a field lens 31 is disposed between the G/R separating dichroic mirror 22 and the total reflection mirror 29, and a relay lens 32 is disposed between the total reflection mirrors 29 and 30, so that the field lens 31 and the relay lens 32 correct the imaging of the R component LR so as to make it apparently identical to that of the B component LB and G component LG. The tricolor-combining prism 24 is a cross prism having a dichroic surface 24B for reflecting the B component LB and a dichroic surface 24R for reflecting the R component LR.

As mentioned above, the illumination apparatus 10 in the projection type display apparatus of the present invention is configured such that a plurality of light source sections 11A, 11B are arranged symmetrical about the optical axis, whereas a part having a higher intensity is collected at a position nearer to the optical axis X of the substantially parallel luminous flux incident on the second flyeye 7. Therefore, on the pupil surface of the projection lens 25 in the projection type display apparatus, which becomes conjugate with the surface of the first flyeye 8, the part having a higher intensity is collected, whereby a bright projection type display apparatus in which the projection lens 25 has a favorable imaging performance can be obtained.

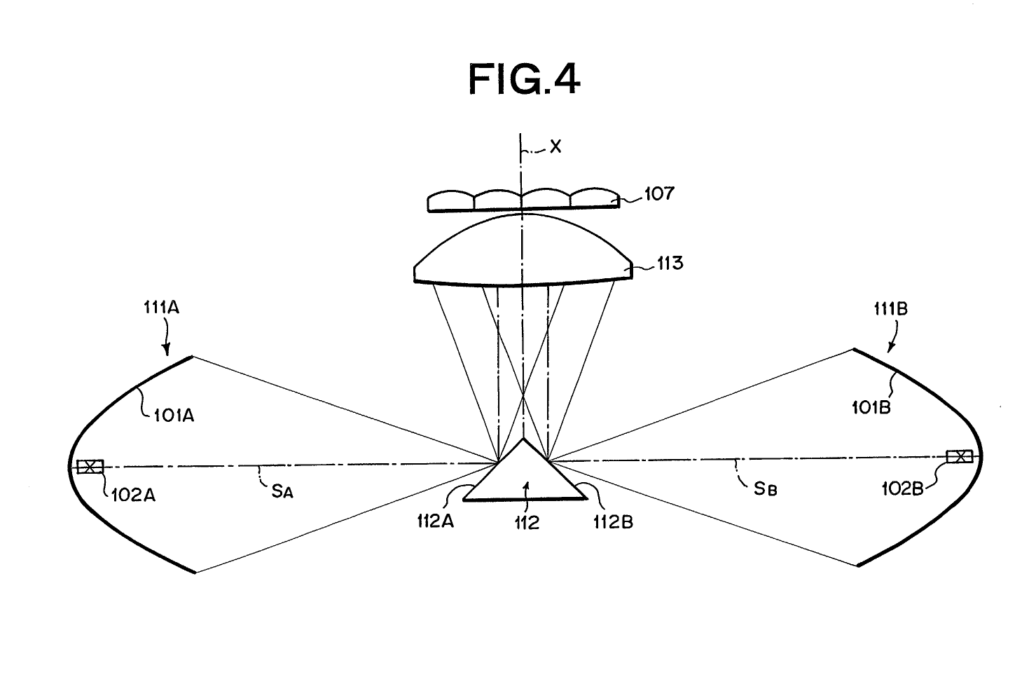

For comparison with this embodiment, FIG. 4 shows the configuration of the corresponding parts in the illumination apparatus in accordance with the above-mentioned conventional example. In this illumination apparatus, members having the same names and functions as those of the members explained in the illumination apparatus in accordance with the above-mentioned embodiment are referred to with numerals having last two digits identical to those of the latter, without repeating their detailed explanations. As shown in FIG. 4, while a mirror element 112 is disposed as in the above-mentioned embodiment so as to place secondary light source images of luminous bodies 102A, 102B nearer to the optical axis X of the illumination apparatus in the conventional example, light source sections 111A, 111B are disposed such that the optical axes S_{A}, S_{B} of reflectors 101A, 101B and the optical axis X of the illumination apparatus are parallel to each other, which differs from the above-mentioned embodiment.

Therefore, while the light spots of the luminous fluxes incident on the lens 13 from the light source sections 11A, 11B can be superposed on each other so as to substantially coincide with each other at the entrance surface in accordance with the present invention, the light spots of the luminous fluxes incident on the lens 113 from the light source sections 111A, 111B are superposed on each other only partly at the entrance surface. Consequently, in order for the same quantity of light to be transmitted through the entrance surface, the conventional example is required to utilize luminous fluxes located farther from the optical axis X. Namely, when the lenses 13, 113 having the same size are used as shown in FIGS. 1 and 4, the center part of lenses can be utilized more efficiently in the above-mentioned embodiment (which is similarly applicable to lenses downstream thereof as well). Also, the flyeyes 7, 8 of the integrator section and the lenses 12, 26 upstream and downstream the integrator section in the above-mentioned embodiment can be made smaller than those in the conventional example.

Without being restricted to those mentioned above, the illumination apparatus and the projection type display apparatus using the same in accordance with the present invention can be modified in various manners. For example, the configurations and forms of lenses can be modified as appropriate. Also, the form of aspheric surface and which surface is to be formed aspheric can be determined arbitrarily.

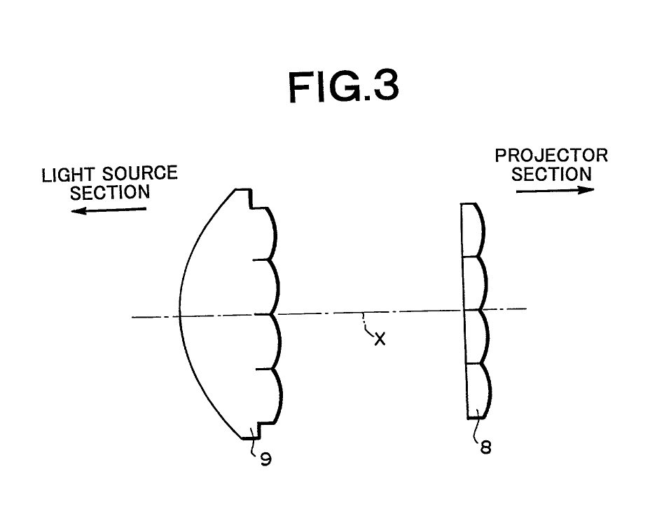

FIG. 3 is an enlarged view of the lens 13 and second flyeye 7 when formed integrally in the illumination apparatus shown in FIG. 1. In the illumination apparatus of the present invention, the lens 13 and the second flyeye 7 downstream thereof may be formed as an integrated lens 9 in which the lens 13 is integrated with the second flyeye 7 on its surface directed onto the light source section 11 as depicted. When such an integrated lens 9 is made by monolithic molding from a plastic material, for example, the manufacturing cost can be lowered. Also, no air interface is formed between the lens 13 and the second flyeye 7, whereby the illuminating efficiency improves.

The number of light source sections in the illumination apparatus in accordance with the present invention is not limited to 2, whereby any number of 2 and greater can be selected. For example, four or nine light source sections can be provided. When the light spot formed by the luminous flux from one of a plurality of light source sections is positioned on the optical axis X, it is unnecessary for this light spot to be moved relative to the optical axis X, whereby this light source section may be free of means for moving the luminous flux. As the lens 13 disposed in front of the second flyeye 7, a plurality of lenses corresponding to different light sources may be provided according to the number of light source sections.

The form of the mirror element 12 used in the illumination apparatus of the present invention is not limited to that mentioned above. Though it is desirable for the mirror element 12 to have reflecting surfaces corresponding to the number of light source sections, the luminous fluxes from all the light source sections are not necessarily reflected by the mirror element 12 so as to deflect their optical paths.

Though the above-mentioned embodiment relates to the case where images are projected after color-separating and color-combining operations in the projection type display apparatus, the present invention is also applicable to image-projecting apparatus carrying out neither color-separating nor color-combining operation as a matter of course.

As explained in the foregoing, the illumination apparatus of the present invention is an illumination apparatus in which a plurality of secondary light source images formed by reflectors each made of an ellipsoidal surface are reflected toward an integrator section by a mirror element, whereas the optical axis of the whole illumination apparatus and the optical axis of each reflector form a predetermined angle therebetween. Consequently, each luminous flux incident on the integrator section becomes a substantially parallel luminous flux in which a part having a higher optical intensity corresponding to the respective light source is superposed so as to substantially align with the optical axis of the illumination apparatus, whereby it is possible to obtain an illumination apparatus which can fully exhibit the imaging performance inherent in the projection lens and can be made smaller.

Since the projection type display apparatus of the present invention comprises the above-mentioned illumination apparatus, the part having a greater light quantity in the luminous flux emitted from the integrator section is incident on the projection lens in the vicinity of the optical axis thereof. Therefore, the present invention can yield a projection type display apparatus which is capable of fully exhibiting the imaging performance of the projection lens.

TABLE 1

| | R | D | Nₑ |
|---|---|---|---|
| 1 | 293.746 | 23.00 | 1.51872 |
| *2 | −40.327 | | |

Aspheric surface coefficient

| Sur- | | | | | |
|---|---|---|---|---|---|
| face | K | A | B | C | D |
| 2 | 0.4737 | 0.3466 × 10⁻⁶ | 0.1039 × 10⁻⁹ | 0.9008 × 10⁻¹³ | 0.000 |

What is claimed is:

1. An illumination apparatus comprising:
a light source group in which a plurality of light source sections, each constituted by a luminous body and a reflector comprising an ellipsoidal surface having one focal point located near a center of gravity of the luminous body, are arranged;
an integrator section, constituted by at least two integrator plates, for homogenizing a quantity of light emitted from said light source group, said integrator section being arranged in an optical axis direction of said light; and
at least one mirror element, having a reflecting surface near the other focal point of said ellipsoidal surface of at least one said reflector, for reflecting a luminous flux from said light source group toward said integrator section;
wherein said illumination apparatus as a whole has an optical axis forming a predetermined angle with an optical axis of said at least one reflector.

2. An illumination apparatus according to claim 1, wherein at least one lens for emitting said luminous flux from said mirror element toward said integrator section as a substantially parallel luminous flux is disposed on said mirror element side of said integrator section.

3. An illumination apparatus according to claim 1, wherein said lens is formed integrally with said integrator plate on said mirror element side in said integrator section on the surface of said integrator plate facing said mirror element.

4. An illumination apparatus according to claim 3, wherein said lens is formed integrally with said integrator plate from a plastic material.

5. An illumination apparatus according to claim 1, wherein said lens has an aspheric surface.

6. An illumination apparatus according to claim 2, wherein said light source group comprises at least two light source sections arranged such that respective luminous fluxes therefrom are incident on said lens at an angle by which a center axis of each of said luminous fluxes substantially intersects said optical axis of said lens.

7. An illumination apparatus according to claim 1, wherein said light source group comprises at least two light source sections, whereas said mirror element has a reflecting surface near the other focal point of said ellipsoidal surface of each of said reflectors of said two light source sections so as to reflect said luminous flux from said light source group toward said integrator section.

8. A projection type display apparatus comprising the illumination apparatus according to claim 1, a light valve for modulating output light from said integrator section according to predetermined image information, and a projection lens for projecting onto a screen an optical image formed by said light modulated by said light valve.
